(19) United States
(12) Patent Application Publication
(10) Pub. No.: US 2020/0315307 A1
(43) Pub. Date: Oct. 8, 2020

(54) Photovoltaic Protective Case

(71) Applicants: Joseph Foreman, Charlotte, NC (US); Derek Brooks, Lexington, MA (US)

(72) Inventors: Joseph Foreman, Charlotte, NC (US); Derek Brooks, Lexington, MA (US)

(21) Appl. No.: 16/851,672

(22) Filed: Apr. 17, 2020

Related U.S. Application Data
(60) Provisional application No. 62/828,745, filed on Apr. 3, 2019.

(51) Int. Cl. A45C 11/00; A45C 15/00; H02J 7/35; H02J 7/02; H02J 7/00

(52) U.S. Cl. CPC A45C 11/00; A45C 15/00; H02J 7/35; A45C 2011/002; H02J 7/0045; H02J 7/0047; H02J 7/02

(57) ABSTRACT

A protective case for a mobile electronic device which features Photovoltaic Solar Panels embedded and installed within the Back Panel of the case itself, facilitating the collection, electronic conversion and subsequent transfer of Solar or Ambient Light Energy, thereby providing the device with full access to a continuously unplugged source of power and recharging; Also, providing complementary ingress protection from water and dust, and exterior and on-screen protection to the mobile electronic device itself, when the electronic device is installed into the protective case. Also features standard case apertures that also provide full access to all standard device functions, peripherals and external user interfaces typically available, on the mobile electronic device; an access receptacle for fully retaining the alternate capability of charging via a standard external USB and/or 110 v electrical peripheral device. Design and Utility elements, and potential of technological licensing applicability are indeed universal across all other embodiments, types and brands of smartphones, tablets, as well as all other mobile electronic devices.

### I. FIELD

The present Application relates to photovoltaic protective cases, for mobile electronic devices. More specifically, the present Application relates to a protective case for electronic devices that provides features for providing seamless untethered photovoltaic recharging, which will be quite synergistic with remotely extending the Battery Life of the mobile smartphone, or mobile electronic device.

### II. BACKGROUND

Mobile Smartphone devices, have now fully escaped their initial realm of pure ‘market convenience’—and are now quite commonly used, for both mission-critical business communication and personal entertainment purposes. Mobile electronic devices may also include devices such as smartphones, cellular phones, mobile communication devices, portable computers, tablet computers, cameras, video players, audio players, electronic media readers, two-way radios, global positioning satellite (GPS) devices, and/or other types of electronic computing or communication devices, including combinations thereof. Previously, the types of protective cases, covers, enclosures, or encasements available for these devices are traditionally deployed in order to protect the devices from damage—due to exposure to shock, impact, dropping, puncture, dust, dirt, water, snow, rain, mud, chemicals, and/or other potentially damaging forces or elements.

Typically, Mobile Electronic Devices are commonly powered by one (or, on occasion, more than one) internal battery, or, other external electrical power sources. At present, within the mobile smartphone market, users of smartphones strive to maintain appropriate levels of power charging of the internal phone battery, by periodic recharging of the smartphone phone via an electrical outlet and/or a separate external power delivery apparatus—all of which presently exist independent of, and separate from the mobile smartphone device itself. These batteries enable electronic devices to be used in a portable manner, and/or, to temporarily operate untethered to a reliable power source. In common present-day utility, these batteries are now fully rechargeable. Mobile Smartphone devices, with increasingly more sophisticated user features—such as with today's Larger Displays and Touchscreens, and increased processing power, will likely consume the available battery power much more quickly. In today's current state, when an electronic device's battery is exhausted, the device may become temporarily unusable—until the battery can be recharged in a “conventional” manner—such as connecting the device to another wired device, an external battery pack, or a grounded power source, such as a 110 v wall outlet.

These existing power recharging solutions, have presented a number of significant practical challenges and shortcomings, to our increasingly ‘Mobile and Transient’ modern society. In the typical case of Standard “Wired” Recharging—carrying, managing and storing the associated Chargers, Cords and/or USB Cables, is often a huge issue—as these cords and chargers often become tangled within themselves, and/or tangled with other cords, cables, or devices. Furthermore, it is quite often very easy for consumers to forget to take the. Charger with them, when departing for a daily destination—and/or, it can be equally challenging to locate the Charger amongst other items being stored in a briefcase, purse, backpack, suitcase, or desk drawer, when it is needed. On a Global basis—Numerous Hotels, Restaurants, Airplanes, Trains, and the like, are absolutely replete with a veritable “Lost & Found” of abandoned Chargers—of all types! Moreover, due to the Drainage of Power from the device, there is often also an emergent time-sensitivity to try and get the charger connected and attached to the mobile smartphone very quickly in order to continue with an important Phonecall or E-mail, without completely losing one's sufficient battery charge.

Accordingly, Battery Capacity frequently becomes a key issue for consumers to solve for, due to a variety of usage factors—including, but not limited to the power requirements of the electronic device, extended usage of the electronic device, physical space constraints of the internal battery, power requirements of any peripheral(s) attached to the electronic device, temperature extremes, unavailability of a power source for charging, decreased battery capacity due to aging of the battery, decreased battery life due to the number of charge/discharge cycles the battery has endured, and/or, various combinations thereof.

All of these factors, taken en masse, can therefore reduce the overall usefulness and reliability of the mobile electronic device—because the usage of the device between recharges is limited and compromised, and the consumer may at least have to temporarily suspend and/or discontinue his/her use—merely due to a depleted battery, until a sufficient power source is located.

Accordingly, the Innovation disclosed herein, provides a much-improved method for solving for all of the above daily issues and concerns. The provisioning of truly untethered, on-demand solar power recharging—including, vastly-improved methods of Visual and Manual Power Management is a much-needed market addition—while fully preserving and greatly enhancing the full functionality, of the mobile device itself.

Although the improvements disclosed herein, are primarily described with respect to the remote photovoltaic charging of Mobile Smartphones—these improvements are equally applicable to any type of mobile electronic device that may be used, including, but not limited to, the other examples of mobile electronic devices that may also be specifically mentioned herein.

### III. SUMMARY

GENERAL: Photovoltaic protective cases for a mobile smartphone or other electronic devices, are disclosed herein. The disclosed protective cases also include standard apertures, which allow for full functionality of the mobile device, connectivity with other devices, may include supplemental power storage capabilities, and/or may also include real-time power management features, associated with the charging of the mobile smartphone device.

In one example, a protective case for use with a mobile smartphone is provided. The protective case includes an outer shell configured with appropriately-sized Photovoltaic Solar Panels, for facilitating the collection, conversion and subsequent transfer of Solar or Ambient Light Energy, thereby providing the device with full access to a continuously unplugged source of power recharging; and simultaneously, protecting the mobile electronic device when the portable electronic device is appropriately installed into said case. The protective case may also include proper apertures in the shell, configured to provide full and complete access to various standard user interfaces, such as a Camera, Flash, External Speakers, Touchscreen, and the like, of the installed portable electronic device. The protective case also includes an internal electrical Qi Induction Coil Transmitter Interface, and micro-circuitry PCB “ASIC” Board, configured to electrically interface and deliver power recharging between the photovoltaic collection panels hereinabove described, and the installed battery of the portable electronic device. Additionally, the protective case may also include a rechargeable battery contained in the shell and configured for recharging a battery of the installed portable electronic device, through the internal electrical connector. Moreover, the protective case may further include a USB or Lightning-standard electrical interface for the potential of electrically interfacing with the rechargeable battery of the protective case externally, to other Mobile devices external to the rechargeable battery of the protective case. Further, the protective case may also include an external USB electrical connector configured for receiving 110 v electrical power from an external power source for recharging the rechargeable battery of the protective case.

While a single embodiment is being presently disclosed, multiple embodiments will become apparent to those skilled in the art from the following detailed description, which shows and describes illustrative embodiments of the invention. As will be realized, the invention is capable of modifications in various aspects, all without departing from the central scope of the present invention. Thus, we are fully envisioning the applicability of this technology, to and for other related embodiments—inter alia, Apple iPad, ASUS Tablet, and the like. Accordingly, the drawings and detailed descriptions offered herein, are to be regarded as illustrative in nature, and in no way restrictive.

### IV. BRIEF DESCRIPTION OF THE DRAWINGS

Embodiments of the present invention will be further described and explained through the use of the accompanying drawings, in which:

FIG. 1 illustrates an outer perspective view of a photovoltaic protective case, depicting the photovoltaic solar capture panels and the visible LED Status Display, fully integrated and embedded thereto;

FIG. 2 illustrates an electrical block diagram view, of our photovoltaic protective case, depicting the power flow and the Qi Wireless Induction Pad layer, fully integrated and embedded therein;

FIG. 3 illustrates an exploded perspective view, of the components of our photovoltaic protective case, depicting the photovoltaic panels, and the interior case components appropriate and pertinent thereto;

FIG. 4 is CANCELLED, per MPEP 608.02(t);

FIG. 5 illustrates an additional exploded perspective view of our photovoltaic protective case, depicting the proximate case seating and alignment of all the interior components pertinent thereto; and

FIG. 6 illustrates a top perspective view of the ASIC Board neatly seated within our photovoltaic protective case, depicting all of the appropriate components pertinent thereto.

### V. DETAILED DESCRIPTION

In the following detailed description, various specific details are set forth in order to provide an understanding of and better describe the apparatus and the innovations introduced here. However, the techniques may be practiced without the specific details set forth in these examples. Various alternatives, modifications, and/or equivalents will be apparent to those skilled in the art, without varying from the spirit of the introduced apparatuses and techniques. For example, while the embodiments described herein may refer to particular features, the scope of this solution may also include embodiments having different combinations of features and embodiments that do not include all of the described features. Accordingly, the scope of the techniques and solutions introduced herein, are intended to embrace all such alternatives, modifications, and variations as fall within the scope of the Claims, together with all equivalents thereof. Therefore, these descriptions should not be taken as limiting the scope of the invention, which is further defined by the Claims.

The photovoltaic solar protective case design elements disclosed herein, may be transferrable to include any other type of case, protective case, cover, protective cover, encasement, protective encasement, shell, protective shell, crush-resistant case, crushproof case, waterproof case, water-resistant case, and/or various creative combinations thereof. The inner shell portion of the protective case may have one or more appropriately-designed clasping mechanisms, for attaching to and for retaining the electronic device. The inner shell portion of the case may have a front portion, a back portion, side portions, a proximal portion, a distal portion, an inner surface, an outer surface, an aperture or multiple apertures, a button feature or multiple button features, a switch feature or multiple switch features, a door or multiple doors, an access port or multiple access ports, and/or other required functional openings, for accessing one or more features of the electronic device.

The photovoltaic solar protective case also includes multiple components, may include rigid components, and may include soft components. The photovoltaic solar protective case may also include a membrane, transparent membrane, or thin film layer which provides a barrier layer of prophylactic dust protection for the various electronic PCB interface features of the case as same are depicted, while the Smartphone is seated inside the solar protective case itself. Any of the components of the photovoltaic solar protective case may be made of any suitable material, and/or combination of materials—including plastic, silicone, elastomer, metal, glass, ceramic, wood, and/or future creative combinations thereof.

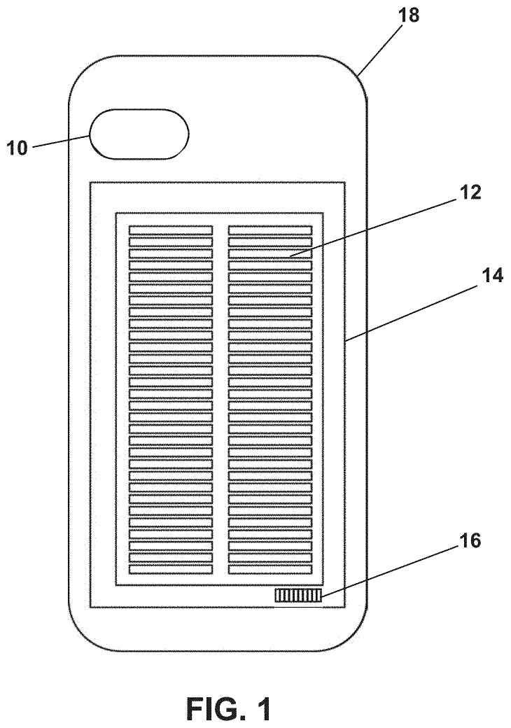

FIG. 1 illustrates an outer perspective view of a Solar Protective Case¹—wherein this view clearly demonstrates the appropriately-sized photovoltaic solar capture panels (12) fully embedded and integrated, attached and implanted thereto, thus creating a “Solar-powered” mobile smartphone case. As depicted, the Solar Protective Case seamlessly affixes itself onto the back of the mobile device, facilitating the collection, conversion and subsequent transfer of Solar or Ambient Light Energy, thereby providing the device with full access to a continuously unplugged source of power recharging. Moreover, the protective case itself also provides a layer of prophylactic ingress and water resistant protection to the electronic device, while simultaneously providing the user with a continuously available additional source of power ¹ For example, the Apple iPhone 8 is the first generation of Apple Smart phone Device presently on the market, which is actually designed to be capable of fully accepting a Qi Wireless induction interface battery charge—so accordingly, it may be instructive to initiate our photovoltaic solar case design, with this particular model. Likewise, these design principles will thus surely apply to all subsequent iPhone and Adjacent model devices, including combinations thereof.

recharging, when the device is installed into the protective case. The LED Status Display, also depicted (16), gives the user a prompt ‘at-a-glance’ view of the current recharging capabilities, of the protective case.

Additionally, the Standard Device Apertures (10) providing access from the outer perspective view (e.g., Camera, Flash) are also fully configured, fitted and exposed on the Solar Protective Case—in order to provide full unfettered access to these necessary user interfaces, on the device itself.

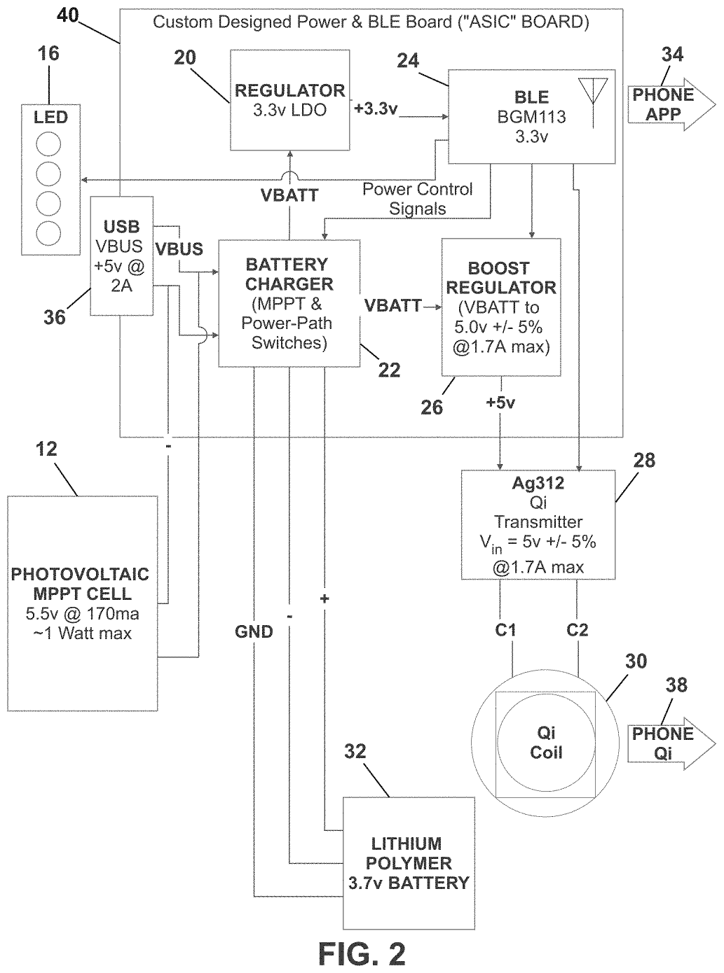

FIG. 2 illustrates a detailed electrical block diagram view of the key components within our Solar Protective Case, wherein the Solar Panels (12) depicted in FIG. 1, are connected and attached via micro-circuitry, to a Micro-Storage Battery Cell or Micro-Power Repository (32), for the temporary collection of captured, converted and stored photovoltaic solar energy. Also, an inner Qi Electrical Connector or Induction Coil Interface (30) will be connected to the Micro-Storage Cell or Repository on the interior of the protective case, thus delivering the collected solar power to the user's device itself (38). Leveraging and utilizing the Wireless Power Transfer (WPT) Qi standard, an example of near-field wireless power transfer, when the User's Smartphone is snapped into our case innovation; and wherein, Power is appropriately captured and delivered via the photovoltaic transfer as previously indicated hereinabove, the Transmitter or ‘TX’ Coil within our Case (30) thus creates a magnetic field, which induces a current in the User's Receiver or “RX” coil, located within the User's Smartphone thereby, successfully charging its battery. The wireless charging via the Qi-Standard may conform to one or more generally-accepted wireless industry charging protocols, including but not limited to Qi, Powermat, A4WP, Rezence, other relevant protocols or standards, or combinations thereof. The Qi Interface may use an induction standard, inductive charging, inductive coupling, resonant inductive coupling, magnetic resonant inductive coupling, or a combination thereof.

Also present in the interior, the photovoltaic solar protective case shall include a membrane, transparent membrane, or thin film shield layer. This ventilated interior shield layer will protect the sensitive inner electrical components from inadvertent tampering or disturbance, during installation onto the back of the user's existing device—and, also provides a barrier of prophylactic dust protection for the various electronic interior circuitry features of the protective case, while the Smartphone is seated inside the solar protective case itself²—thereby further reinforcing the overall product durability, of the case innovation. The only fully-exposed component within the interior of the protective case (via a customized ‘cut-out’, within the shield itself) shall be the Qi transmission induction coil surface which, by functional necessity, must maximize the proximity of its surface area to the existing internal Qi receiver, contained within the user's smartphone device. ² in some configurations, the solar protective case may provide prophylactic physical protection to the mobile device in question, when said device is inserted. Protection may include protection from bumps, dropping, impact, jarring, electrical shock, dirt, dust, mud, mist, rain, water, or snow. These solar protective cases may also have various rigid and/or compliant components for protecting the electronic device from shock, impact, vibration, dirt, rain, snow, dust, puncture, extreme acceleration, and/or other potentially damaging forces or elements.

The techniques and improvements described herein are not to be limited to any particular type of protective case and may be used with many different types of protective cases. Protective cases using one or more of the techniques disclosed herein may or may not be water-resistant or water-proof in some configurations, the protective functions described above may also be implemented with respect to other peripherals, including wired peripherals, which are attached to the protective case and/or to the mobile electronic device inside the protective case.

Moreover, slight slotted vent apertures will be designed into the case itself, in order to fully meet and support the requisite consumer electrical safety standards and ensuring the appropriate ventilation and heat dispersion quotients will be met, during the recharging activities of the battery for the particular mobile device which the case is presently attached.

In some embodiments, the solar protective cases described herein may also include additional features for assisting in the operation of, or further enhancing the operation of the smartphone or mobile device. For example, also depicted in FIG. 2, the Solar-to-Qi power conversion delivery and micro-circuitry as indicated above, will also be Bluetooth-Discoverable, via embedded deployment of a Bluetooth Sensor (24), into the solar protective case—and, the protective case itself will also be designed with a downloadable Companion Software Application (“App”), thereby providing a user-friendly on-demand display of Power Management elements (34)—in order to appropriately track and monitor the Status of the photovoltaic storage, available power, power collection, and power transfer that is taking place on the mobile device, in real time. Accordingly, the solar protective case will thus be capable of communicating with the electronic device through a wireless connection via utilization and integration of an industry-standard Bluetooth Sensor, or Bluetooth Low Energy (BLE) Sensor Antenna connection (24). It is also instructive to note, that there will be no Bluetooth Distance Restrictions, or other similar spatial signal transmission issues, to be concerned with—s the Bluetooth Sensor will be wholly enclosed and encased within the solar phone case, tightly integrated against the device itself.

Beneficially, the solar protective case will also automatically detect when a device is appropriately docked or attached, and communicate this information or make it available to the User's electronic device via the downloadable “App”, as indicated above (34). As an example, based on the on-demand information gleaned via the Bluetooth App, the electronic device may be switched and/or, may be set to switch itself from, e.g., “Full Power” consumption mode, to a “Power-Saving” consumption mode, and the like.

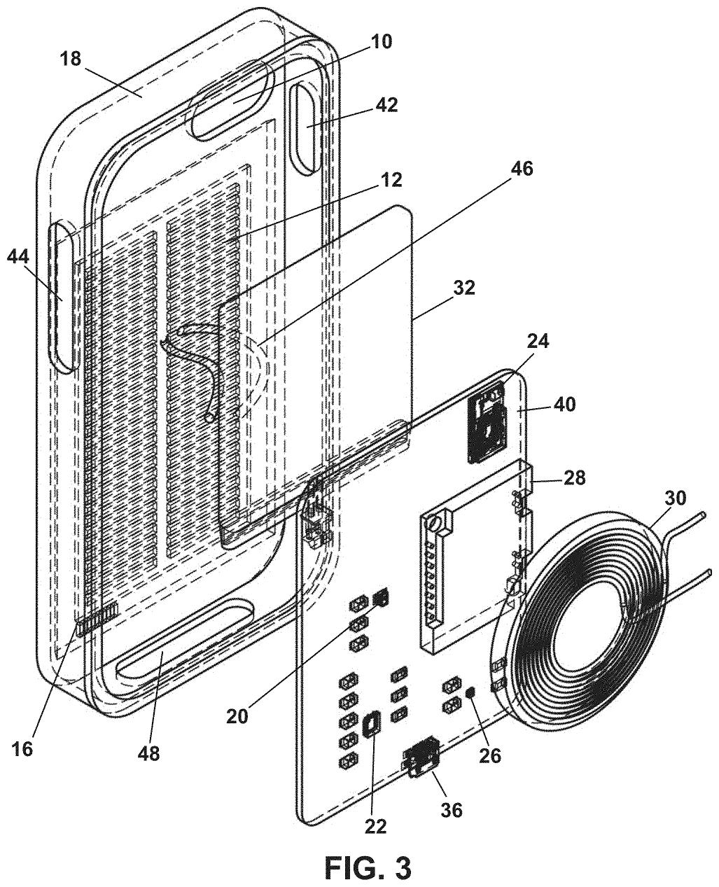

FIG. 3 illustrates an exploded perspective view of the key electronics within our Solar Protective Case, wherein the further detailed depiction of the interior of the solar protective case clearly shows the photovoltaic panel wired and affixed thereto (46), and with the desired electrical specification voltages depicted, within FIG. 2. Positioning of the Panels on the Case in this fashion, will not interrupt or disturb the utility of the Smartphone, and will also provide and preserve full access to all of the standard mobile device functions, peripheral slots, and/or external user interfaces typically available (42, 44, 48), on the User's Smartphone device (i.e. camera/flash, push-button volume up/down, ringer on/off toggle, USB).

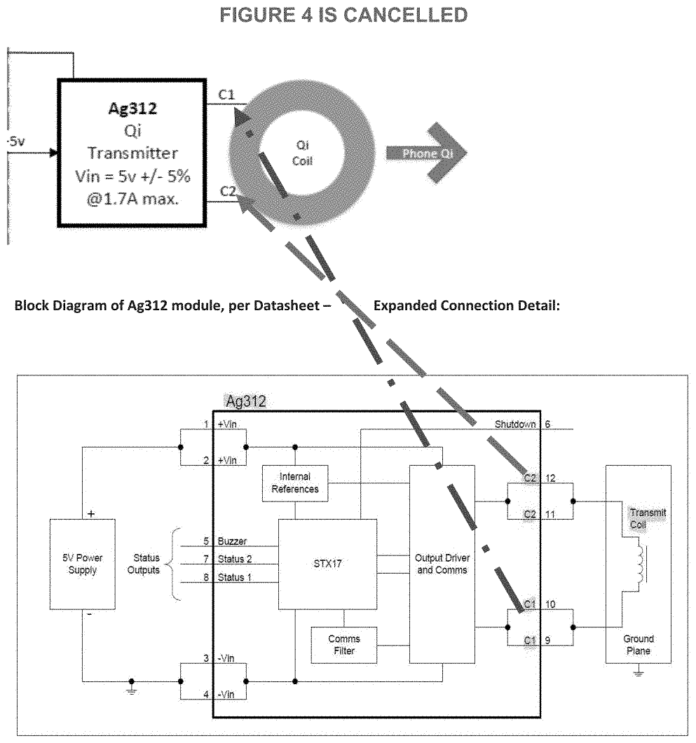

FIG. 4 is CANCELLED, per MPEP 608.02(t).

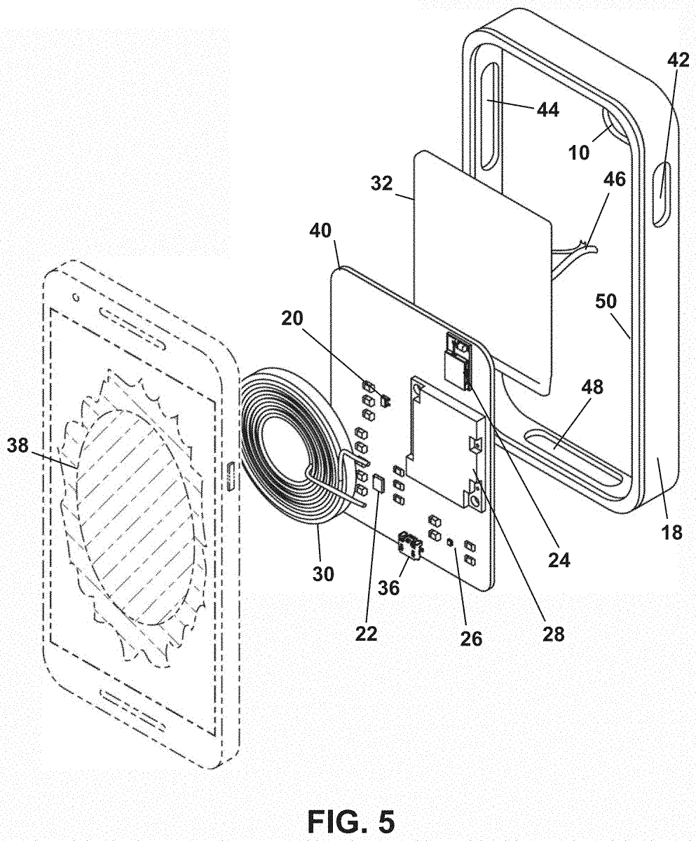

FIG. 5 illustrates an additional exploded perspective view of the components within our Solar Protective Case, wherein as demonstrated, the User's Smartphone device will “Snap-fit” into our Case, as indicated within the illustration shown. It is presently surmised that we will utilize a 3D-Printable SLA Material for production of the Case, that is somewhat similar in quality to a firm-rubber material—in order to provide some necessary impact resistance for the User, as well as the ability to stretch it over the edges of the User's Smartphone device without having to employ multiple sections or fasteners.

The Qi Induction Coil (30) will be rigidly attached to the interior of the protective case, and will be specifically engineered and hard-wired via micro-circuitry, to and for the respective Brand and Model of mobile device, upon which it is installed. As shown within FIG. 5, the Qi induction Coil Transmitter interface will be situated, such that it will become properly affixed and positioned exactly adjacent to the Qi Receiver of the User's mobile Smartphone device (38), when said mobile device is inserted into the protective case—without any specific further manipulation or interaction from the user, other than the normal insertion of the appropriate model device into the suitable protective case.

The solar protective case disclosed herein, will also include an Electromechanical Toggle Switch to be located in the vacant available space on the top-side position of the Case, that the user toggles to indicate whether the charging capabilities should be used. This provides the user with the option to shut down and temporarily discontinue the Solar power supply, to the Qi induction pad. This feature is intended to prevent overcharging the case user's mobile device. The toggle switch embedded within the case frame allows the user to wait until their mobile device battery gets to lower levels, allowing the user to thus initiate the transfer of the photovoltaic source power to the induction layer, at their discretion, The intention is to avoid overcharging, and maximize the battery life of the mobile smartphone device. In this manner, electronic communication between the solar protective case and the associated electronic device via Bluetooth Sensor (24) as indicated hereinabove, is also synergistically necessary—in order to transmit the ‘Current State’ of the Toggle Switch, to the electronic device. Without this type of communication between the protective case and the electronic device, the electronic device may otherwise detect that charging power is always necessary.

Also visible from this exploded perspective view in FIG. 5, includes a raised Bezel Edge on the Case (50)—thereby, providing the necessary exterior screen protection to the User from gravitationally dropping the device to the ground, thus more fully protecting the mobile electronic device itself—when the electronic device is properly installed into the solar protective case as demonstrated.

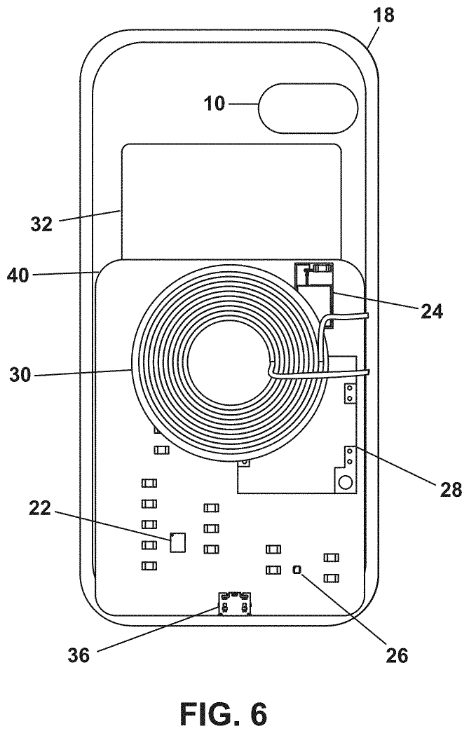

FIG. 6 illustrates a top perspective view of the ASIC Board (40), neatly seated within our photovoltaic protective case—again, depicting all of the appropriate components pertinent thereto. From this vantage point, one can clearly see how the components are synergistically-designed, to fit neatly and ergonomically within the allowable space of our case innovation.

### VI. ADDITIONAL EMBODIMENTS

In some embodiments, the solar protective cases described in detail hereinabove, may also include additional features for assisting in the operation of or enhancing the operation of the smartphone or mobile device:
a) In one variation of all the above, it should also be understood that these innovations are quite applicable to also providing an external ‘power or charging function’—which, will also be included here. Wherein, the solar protective case will also further comprise an alternate power receptacle (Le., USB/Lightning/IEEE 1394, etc.)—including, a second power engagement mechanism for the external provisioning and charging, of the case itself; wherein, supplemental charging power is thus independently acquired and retained by way of said second case receptacle; thereby allowing the user to “pre-charge” the solar case to 100% capture capacity, well in advance and in full anticipation of a potential long trip or excursion, where the user may anticipate being off-grid for an extended period of time, and/or traveling to and through a remote power access area. Beneficially, external charging of the solar protective case when the mobile device is not in full increases the amount of battery power available—and, extends the remote operational life available to the user, when the mobile device is in full use.
b) In yet another variation, stored photovoltaic energy in a spare battery and/or micro-storage cell may also be freely accessed via a USB Port or otherwise, on the solar protective case—in order to also charge an external device and/or rechargeable battery, while a mobile smartphone device is seated in the case. Through an available USB Port, the versatility of the charging capabilities of the protective case may also be re-directed to charging the primary mobile electronic device inserted into the case, charging another external mobile device, and/or may be used for charging a combination of these devices, either sequentially or simultaneously.

### VII. CONCLUSION

The components and configurations more fully described hereinabove, are meant to further exemplify some types of commercial possibilities. In no way should the examples provided herein limit the scope of the invention, as they are only exemplary embodiments.

Achieving an ingress protection rating of IP67 during the manufacturing stage, is also a desired design constraint and a desired outcome of our eventual Production Models. While it is instructive to note that in the actual Production Models, there may be slight variations and refinements made, this depiction represents a workable construct from which to proceed and fully assimilate.

As aptly described in the examples herein, and in other embodiments, the photovoltaic protective case may, or may not itself contain a battery—but, will surely include an electrical Solar-to-Qi-Standard micro-circuitry connection, to the mobile electronic device—which, will thus enable the battery of the mobile electronic device to be fully recharged, when the device is appropriately seated into the solar protective case. In other words, through photovoltaic transfer alone, the solar protective case will thus fully facilitate the transfer of available recharging power from the protective case, to the electronic device.

The foregoing disclosure has been presented, for purposes of illustration and description. Other modifications and variations may be possible, in view of the above teachings. The embodiments described in the foregoing disclosure were chosen to explain the principles of the concept, and its practical application—in order to enable others skilled in the art, to best utilize the invention. It is intended that the detailed Claims made herein be construed to include other alternative embodiments of the invention, except as limited by the prior art.

The phrases “in some embodiments,” “according to some embodiments,” “in the embodiments shown,” “in other embodiments,” “in some examples,” “in other examples,” “in some cases,” “in some situations,” “in one variation”, “in some configurations”, “in one configuration,” “in another configuration,” and the like generally mean that the particular innovation, technique, feature, structure, or characteristic following the phrase is included in at least one embodiment of the present invention, and/or may be included in more than one embodiment of the present invention. In addition, such phrases do not necessarily refer to the same embodiments, or to different embodiments.

1. A protective back cover case for a mobile smartphone electronic device, the protective case comprising:
Embedded integration of Photovoltaic Solar Capture Panels of suitable dimensions, fully attached and implanted thereto, thus creating a “Solar-powered” mobile smartphone case; wherein, the protective case seamlessly affixes itself onto the back of the mobile device, facilitating the collection, conversion and subsequent transfer of Solar or Ambient Light Energy, thereby providing the device with full access to a continuously unplugged source of power recharging; wherein, the protective case also provides a shield layer of prophylactic ingress and water resistant protection to the electronic device, while simultaneously providing the user with a continuously available additional source of power recharging, when the electronic device is installed into the protective case; wherein, the standard device apertures are also fully configured to provide full access to all of the existing user interfaces of the mobile electronic device; as well as to provide suitable access receptacles to fully retain the alternate capability of charging via a standard external USB and/or 110 v electrical power source.

2. The protective case of claim 1, wherein the Solar Panels embedded within the case itself, are connected and attached via micro-circuitry, to a Micro-Storage Cell or Micro-Power Repository, for the temporary collection of captured, converted and and stored photovoltaic energy.

3. The protective case of claim 1, wherein the Solar Panels and Storage Cells of claim 2 are also connected and attached via micro-circuitry, to an inner Qi Wireless Induction Pad Transmitter Layer, delivering power to the device—which is also fully integrated and encased within the protective case and cover frame.

4. The protective case of claim 1, wherein the case frame shall have an embedded on/off Toggle Switch which provides the user with the option to shut down and temporarily discontinue the Solar power supply, to the Qi induction pad. This feature is intended to prevent overcharging, and to maximize the battery life of the mobile smartphone device. The toggle switch embedded within the case frame allows the user to wait until their mobile device battery gets to lower levels, allowing the user to thus initiate the transfer of the photovoltaic source power to the induction layer, at their discretion.

5. The protective case of claim 1, wherein the first surface is a front surface of the protective case and the second surface is a back surface of the protective case, providing complementary ingress protection from water and dust; and also, wherein the protective case includes a top raised edge, a left side raised edge, a right side raised edge opposite the left side edge, and a bottom raised edge, thereby providing exterior on-screen protection to the mobile electronic device itself, when the electronic device is installed into the protective case.

6. The protective case of claim 1, wherein the protective case features all standard case apertures that also provide full access to all standard device functions, peripherals and external user interfaces typically available, on the mobile electronic device (i.e., camera, flash, audio speakers, etc.); and wherein, access receptacles for fully retaining the alternate capability of charging via ordinary external USB and/or 110v electrical peripheral devices, are also proximately located, and remain fully accessible by the user.

7. The protective case of claim 1, further comprising an alternate power receptacle including a second power engagement mechanism for the exterior provisioning and charging of the case itself; wherein, power is thus independently retained within said second case receptacle; thereby allowing the user to “pre-charge” the solar case to 100% capture capacity, well in advance and in full anticipation of a potential long trip or excursion wherein the user may anticipate being off-grid, traveling to and through a remote power access area.

8. The protective case of claim 1, further comprising Solar-to-Qi power conversion delivery and micro-circuitry, wherein the integration of the Qi induction pad will be designed and positioned in full accordance with required, adopted and well-established mobile smartphone manufacturer and wireless industry standards and specifications, in order to fully support and sustain the supplemental recharging activities of the battery for the particular mobile device to which the case is presently attached.

9. The protective case of claim 1, wherein the Solar-to-Qi power conversion delivery and micro-circuitry as indicated above in claim 8, will be designed in full accordance with required, adopted and well-established industry standards and specifications, in order to fully meet and support the requisite consumer and FCC certification and electrical safety standards, and ensuring the appropriate ventilation and heat dispersion quotients will be met, during the recharging activities of the battery for the particular mobile device to which the case is presently attached.

10. The protective case of claim 1, wherein the Solar-to-Qi power conversion delivery and micro-circuitry as indicated above in claim 8, will also be Bluetooth-Discoverable and, the protective case itself will be designed with a downloadable Companion Application (“App”), thereby providing a user-friendly display of Power Management elements—in order to appropriately track and monitor the Status of the photovoltaic storage, collection, and power transfer that is taking place on the mobile device, in real time,

11. The protective case of claim 1, wherein the back cover of the protective case itself will also feature a Simple LED Meter Display, thereby providing a quick ‘at-a-glance’ view, of available Solar Recharging capability—in order to further assist, track and monitor the Status of the photovoltaic storage, collection, and power transfer that is taking place on the mobile device, in real time.

12. The protective case of claim 1, wherein the engagement mechanism of the case itself will ensure a tight and snug fit onto the mobile device, for the contemplated application—by employing generally-accepted mechanical engineering molding standards, including but not necessarily limited to: a snap, a tab, a clip, a magnet, a flexible element, a spring, a twist lock feature, a threaded portion, a friction fit, an interference fit, or any combination thereof; and/or, a piece or composite of any otherwise-compliant material.

13. The protective case of claim 1, wherein the protective case is also adapted via USB and/or Lightning Port Capability, to enable electrical charging to and/or from an external wireless device.

14. The protective case of claim 1, wherein the protective case may also further comprise a spare battery, for charging an additional externally-connected wireless mobile device.
